(19) United States
(12) Patent Application Publication
(10) Pub. No.: US 2023/0339768 A1
(43) Pub. Date: Oct. 26, 2023

(54) PRODUCTION OF INORGANIC SALTS

(71) Applicant: UCL BUSINESS LTD, London (GB)

(72) Inventors: Qiming WANG, London (GB); Bolun WANG, London (GB); Feng WENG, London (GB)

(21) Appl. No.: 18/042,899

(22) PCT Filed: Aug. 11, 2021
(86) PCT No.: PCT/GB2021/052081

§ 371 Date: Feb. 24, 2023

(30) Foreign Application Priority Data
Aug. 26, 2020 (GB) 2013382.3

(51) Int. Cl. C01D 3/02; C01F 11/22; C01F 7/78; C01F 17/36

(52) U.S. Cl. CPC C01D 3/02; C01F 11/22; C01F 7/78; C01F 17/36; C01P 2002/77; C01P 2002/72

(57) ABSTRACT

Described herein is a process for converting halocarbons into inorganic salts comprising a halogen, the process comprising reacting a halocarbon with a metal salt to produce the inorganic salt comprising a halogen; wherein the metal salt comprises a metal and an electronegative element selected from nitrogen, oxygen, sulfur, chlorine, selenium, bromine and iodine, or a mixture thereof; wherein the halogen of the halocarbon is more electronegative than the electronegative element of the metal salt.

### BACKGROUND

Many inorganic salts comprising a halogen are commercially important materials. For example, cryolite (Na₃ AlF₆) is used in the refining of aluminium. Although cryolite is a naturally occurring mineral, it is very rare and is generally produced synthetically, typically from hydrogen fluoride, aluminium oxide and sodium hydroxide (6 NaOH+Al₂O₃+12HF→2Na₃AlF₆+9H₂O).

Other uses of halogens include halogen-containing organic compounds, such as halopolymers (e.g., fluoropolymers). However, many halogen-containing polymers cannot currently be recycled, leading to significant amounts of waste that is disposed of in landfill. Moreover, many halocarbons are hazardous to the environment. In particular, the release of chlorofluorocarbons (CFCs) and hydrochlorofluorocarbons (HCFCs) into the atmosphere was proven to deplete the ozone layer.

Current research into making polymers more environmentally friendly focusses on either recycling processes to allow new product to be produced from an old one or creating new polymers that are biodegradable.

However, in view of the many commercial uses for halogens, a method of recovering the halogen atoms from halogen-containing compounds would reduce the production of waste, while increasing the availability of halogens for other uses.

### BRIEF DESCRIPTION OF THE FIGURES

FIG. 1 shows the X-ray diffraction (XRD) patterns and change in crystal structure for conversion of Na₂O to NaF and CaO to CaF₂. During the reaction, Na₂O and CaO are in situ obtained via the decomposition of Na₂CO₃ and CaCO⁺.

FIG. 2 shows the XRD pattern and change in crystal structure for conversion of α-Al₂O₃ to Na₃AlF₆. Na₂CO₃ is used to supply Na⁺.

FIG. 3 shows the XRD pattern and change in crystal structure for the conversion of Y₂O₃ to α-NaYF₄ and β-NaYF₄. Na₂CO₃ is used to supply Na⁺.

### DETAILED DESCRIPTION

Before the present disclosure is disclosed and described, it is to be understood that this disclosure is not limited to the particular process steps and materials disclosed herein because such process steps and materials may vary somewhat. It is also to be understood that the terminology used herein is used for the purpose of describing particular embodiments. The terms are not intended to be limiting because the scope is intended to be limited by the appended claims and equivalents thereof.

It is noted that, as used in this specification and the appended claims, the singular forms “a,” “an,” and “the” include plural referents unless the context clearly dictates otherwise.

As used herein, “co-polymer” refers to a polymer that is polymerized from at least two monomers.

If a standard test is mentioned herein, unless otherwise stated, the version of the test to be referred to is the most recent at the time of filing this patent application.

As used herein, the term “about” is used to provide flexibility to a numerical range endpoint by providing that a given value may be a little above or a little below the endpoint to allow for variation in test methods or apparatus. The degree of flexibility of this term can be dictated by the particular variable and would be within the knowledge of those skilled in the art to determine based on experience and the associated description herein.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include not just the numerical values explicitly recited as the limits of the range, but also to include all the individual numerical values or sub-ranges encompassed within that range as if each numerical value and sub-range is explicitly recited. As an illustration, a numerical range of “about 1 wt. % to about 5 wt. %” should be interpreted to include not just the explicitly recited values of about 1 wt. % to about 5 wt. %, but also to include individual values and sub-ranges within the indicated range. Thus, included in this numerical range are individual values such as 2, 3.5, and 4 and sub-ranges such as from 1-3, from 2-4, and from 3-5, etc. This same principle applies to ranges reciting a single numerical value. Furthermore, such an interpretation should apply regardless of the breadth of the range or the characteristics being described.

As used herein, unless otherwise stated, wt. % values are to be taken as referring to a weight-for-weight (w/w) percentage of solids in the composition, and not including the weight of any fluid present.

Unless otherwise stated, any feature described herein can be combined with any aspect or any other feature described herein.

In an aspect, there is provided a process for converting halocarbons into inorganic salts comprising a halogen. The process for converting halocarbons into inorganic salts comprising a halogen may comprise:
reacting a halocarbon with a metal salt to produce the inorganic salt comprising a halogen,
wherein the metal salt may comprise a metal and an electronegative element selected from nitrogen, oxygen, sulfur, chlorine, selenium, bromine and iodine, or a mixture thereof;
wherein the halogen of the halocarbon is more electronegative than the electronegative element of the metal salt.

Inorganic salts containing halogen atoms are important materials in many industrial processes. For example, about 26% of fluorine currently used in the chemical industry is used in metal fluorides, while only about 3.5% is used to produce fluoropolymers. However, fluoropolymers, once used, generally cannot currently be recycled. Indeed, for currently every kilogram of fluoropolymer waste generated, about 0.75 kg of fluorine is wasted.

The presently described process can be used to convert this waste halocarbons, such as fluoropolymers, into important inorganic salts, including inorganic fluorides, such as Na₃YF₆ and NaF, while the carbon in the halocarbon is converted into another carbon containing compound, such as carbon monoxide. This two-step cascade reaction exploits the decomposition of halogen-containing polymers into their constituent halogen-containing monomers, which then react with a metal salt containing a less electronegative element to form the inorganic metal halogen salt and a new carbon containing compound, such as carbon monoxide.

### Process for Converting Halocarbons into Inorganic Salts Comprising a Halogen

In an aspect, there is provided a process for converting halocarbons into inorganic salts comprising a halogen. In some examples, the process comprises reacting a halocarbon with a metal salt to produce the inorganic salt comprising a halogen; wherein the metal salt comprises a metal and an electronegative element selected from nitrogen, oxygen, sulfur, chlorine, selenium, bromine and iodine, or a mixture thereof; wherein the halogen of the halocarbon is more electronegative than the electronegative element of the metal salt.

In some examples, the process for converting halocarbons into inorganic salts comprising a halogen may be a continuous or batch process.

In some examples, reacting a halocarbon with a metal salt comprises heating the halocarbon in the presence of the metal salt. In some examples, heating the halocarbon in the presence of the metal salt comprises heating at a temperature of at least about 450 K, for example, at least about 500 K, at least about 550 K, at least about 600 K, at least about 650 K, at least about 700 K, at least about 750 K, at least about 800 K, at least about 850 K, at least about 900 K, at least about 950 K, at least about 1000 K, at least about 1100 K, at least about 1200 K, at least about 1300 K, at least about 1400 K, at least about 1500 K, at least about 1600 K, at least about 1700 K, at least about 1800 K, at least about 1900 K, at least about 2000 K, at least about 2100 K, at least about 2200 K, at least about 2300 K, at least about 2400 K, at least about 2500 K, at least about 2600 K, at least about 2700 K, at least about 2800 K, at least about 2900 K, at least about 3000 K, at least about 3100 K, at least about 3200 K, at least about 3300 K, at least about 3400 K, or at least about 3500 K. In some examples, heating the halocarbon in the presence of the metal salt comprises heating at a temperature of up to about 3500 K, for example, up to about 3400 K, up to about 3300 K, up to about 3200 K, up to about 3100 K, up to about 3000 K, up to about 2900 K, up to about 2800 K, up to about 2700 K, up to about 2600 K, up to about 2500 K, up to about 2400 K, up to about 2300 K, up to about 2200 K, up to about 2100 K, up to about 2000 K, up to about 1900 K, up to about 1800 K, up to about 1700 K, up to about 1600 K, up to about 1500 K, up to about 1400 K, up to about 1300 K, up to about 1200 K, up to about 1100 K, up to about 1000 K, up to about 950 K, up to about 900 K, up to about 850 K, up to about 800 K, up to about 750 K, up to about 700 K, up to about 650 K, up to about 600 K, up to about 550 K, up to about 500 K, or up to about 450 K. In some examples, heating the halocarbon in the presence of the metal salt comprises heating at a temperature of from about 450 K to about 3500 K, for example, about 500 K to about 3500 K, about 550 K to about 3400 K, about 600 K to about 3300 K, about 650 K to about 3200 K, about 700 K to about 3100 K, about 750 K to about 3000 K, about 800 K to about 2900 K, about 850 K to about 2800 K, about 900 K to about 2700 K, about 950 K to about 2600 K, about 1000 K to about 2500 K, about 1100 K to about 2400 K, about 1200 K to about 2400 K, about 1300 K to about 2300 K, about 1400 K to about 2200 K, about 1500 K to about 2100 K, about 1600 K to about 2000K, about 1700 K to about 1900 K or about 450 K to about 1800 K.

In some examples, reacting the halocarbon with the metal salt comprises heating for at least 3 hours, for example, at least 3.5 hours, at least 4 hours, at least 4.5 hours, at least 5 hours, at least 5.5 hours, at least 6 hours, at least 6.5 hours, at least 7 hours, at least 7.5 hours, at least 8 hours, at least 8.5 hours, at least 9 hours, at least 9.5 hours, or at least 10 hours. In some examples, reacting the halocarbon with the metal salt comprises heating for up to 7 days, for example, up to 3 days, up to 2 days, up to 1 day, up to 12 hours, up to 10 hours, up to 9 hours, up to 8.5 hours, up to 8 hours, up to 7.5 hours, up to 7 hours, up to 6.5 hours, up to 6 hours, up to 5.5 hours, up to 5 hours, up to 4.5 hours, up to 4 hours, up to 3.5 hours, or up to 3 hours. In some examples, reacting the halocarbon with the metal salt comprises heating for from about 3 hours to about 7 days, for example, 3.5 hours to 3 days, 3 hours to 2 days, 3.5 hours to 10 hours, 4 hours to 9.5 hours, 4.5 hours to 9 hours, 5 hours to 8.5 hours, 5.5 hours to 8 hours, 6 hours to 7.5 hours, or 6.5 hours to 7 hours.

In some examples, the halocarbon is a polymeric halocarbon and the polymeric halocarbon is decomposed into haloalkenes prior to reacting the halocarbon with the metal salt. In some examples, the polymeric halocarbon is decomposed into haloalkenes by heating the polymeric halocarbon. In some examples, the polymeric halocarbon decomposes into haloalkenes at a lower temperature than the temperature at which the halocarbon reacts with the metal salt. In some examples, the polymeric halocarbon decomposes into haloalkenes at a higher temperature than the temperature at which the halocarbon reacts with the metal salt. In some examples, the process for converting polymeric halocarbons into inorganic salts comprising a halogen comprises a two-step cascade reaction in which the polymeric halocarbon is first decomposed into haloalkenes and then the haloalkenes react with a metal salt to produce the inorganic salt comprising a halogen.

In some examples, the decomposition of the polymeric halocarbon occurs in the presence of the metal salt. In some examples, the polymeric halocarbon is decomposed into haloalkenes prior to addition of the metal salt.

In some examples, the halocarbon is reacted with the metal salt in an inert atmosphere. In some examples, the polymeric halocarbon is decomposed into a haloalkene in an inert atmosphere. In some examples, the inert atmosphere may be a nitrogen atmosphere or an argon atmosphere. In some examples, the inert atmosphere is a nitrogen atmosphere.

In some examples, the halocarbon is reacted with the metal salt under a constant flow of an inert gas, for example, nitrogen or argon. In some examples, the constant flow of an inert gas may be at a rate of about 0.5 L/min or more, for example, about 0.6 L/min or more, about 0.7 L/min or more, about 0.8 L/min or more, about 0.9 L/min or more, about 1 L/min or more, about 1.1 L/min or more, about 1.2 L/min or more, about 1.3 L/min or more, about 1.4 L/min or more, about 1.5 L/min or more, about 2 L/min or more, about 2.5 L/min or more, about 3 L/min or more, about 5 L/min or more, or about 50 L/min or more. In some examples, the constant flow of an inert atmosphere may be at a rate of about 50 L/min or less, for example, about 5 L/min or less, about 3 L/min or less, 2.5 L/min or less, 2 L/min or less, 1.5 L/min or less, about 1.4 L/min or less, about 1.3 L/min or less, about 1.2 L/min or less, about 1.1 L/min or less, about 1 L/min or less, about 0.9 L/min or less, about 0.8 L/min or less, about 0.7 L/min or less, about 0.6 L/min or less, or about 0.5 L/min or less. In some examples, the constant flow of an inert atmosphere may be at a rate of from about 0.5 L/min to about 50 L/min, for example, about 0.6 L/min to about 5 L/min, about 0.7 L/min to about 3 L/min, about 0.8 L/min to about 2.5 L/min, about 0.9 L/min to about 2 L/min, about 1 L/min to about 1.5 L/min, about 1.1 L/min to about 1.4 L/min, 0.5 L/min to 1.3 L/min, or 1 L/min to 1.2 L/min.

In some examples, reacting a halocarbon with a metal salt to produce an inorganic salt comprising a halogen comprises combining the halocarbon with the metal salt and then reacting the halocarbon with the metal salt to produce the inorganic salt. In some examples, the halocarbon is combined with the metal salt by mixing or grinding. In some examples, the mixing is high shear mixing. In some examples, the halocarbon is combined with the metal salt and then mixed or ground. In some examples, the halocarbon is combined with the metal salt and then ground. In some examples, the halocarbon and the metal salt are mixed or ground for at least 10 minutes, for example, at least 15 minutes, at least 20 minutes, at least 30 minutes, at least 40 minutes, at least 45 minutes, at least 50 minutes, at least 1 hour, at least 1.5 hours, at least 2 hours, at least 4 hours, at least 12 hours, or at least 24 hours. In some examples, the halocarbon and the metal salt are mixed or ground for up to 24 hour, for example, up to 12 hours, up to 4 hours, up to 2 hours, up to 1.5 hours, up to 1 hour, up to 50 minutes, up to 45 minutes, up to 40 minutes, up to 30 minutes, up to 25 minutes, up to 20 minutes, up to minutes, up to 10 minutes. In some examples, the halocarbon and the metal salt are mixed or ground for from 10 minutes to 24 hours, for example, 15 minutes to 12 hours, 20 minutes to 4 hours, 25 minutes to 2 hours, 30 minutes to 1.5 hours, 10 minutes to 1 hour, 15 minutes to 50 minutes, 20 minutes to 45 minutes, 25 minutes to 40 minutes, or 30 minutes to 40 minutes.

In some examples, the metal salt comprises a metal and oxygen and the by-products of the process are selected from carbon monoxide, carbon dioxide, water, organic compounds of carbon, hydrogen and oxygen, and mixtures thereof. In some examples, the metal salt comprises a metal and oxygen and the by-products of the process are selected from carbon monoxide, carbon dioxide, water and mixtures thereof. In some examples, the metal salt is a metal oxide and the by-products of the process comprise carbon monoxide. In some examples, the metal salt is a metal carbonate that decomposes into carbon dioxide and a metal oxide which reacts with the halocarbon to form the inorganic salt comprising a halogen.

In some examples, the process for converting a halocarbon into an inorganic salt comprising a halogen comprises combining a halocarbon with a metal salt and then reacting the halocarbon with the metal salt. In some examples, the process for converting a halocarbon into an inorganic salt comprising a halogen comprises grinding a halocarbon with a metal salt and then reacting the halocarbon with the metal salt.

In some examples, the process for converting a halocarbon into an inorganic salt comprising a halogen comprises heating a halocarbon in the presence of a metal salt. In some examples, the process for converting a halocarbon into an inorganic salt comprising a halogen comprises combining a halocarbon with a metal salt and heating. In some examples, the process for converting a halocarbon into an inorganic salt comprising a halogen comprises combining a halocarbon with a metal salt; grinding; and then heating.

In some examples, after reacting the halocarbon with the metal salt to produce an inorganic salt comprising a halogen, calcination may be performed. In some examples, calcination may remove deposited carbon from the inorganic salt comprising a halogen. In some examples, calcination may comprise heating in air or oxygen. In some examples, calcination may comprise heating to a temperature of at least about 600 K, for example, at least about 650 K, at least about 670 K, or at least about 700 K. In some examples, calcination may comprise heating to a temperature of up to 800 K, for example up to about 750 K, up to about 700 K, or up to about 675 K. In some examples, calcination may comprise heating to a temperature of from about 600 K to about 800 K, for example, from about 650 K to about 750 K, or from about 670 K to about 700 K. In some examples, calcination may comprise heating for at least 3 hours, for example, at least 3.5 hours, or at least 4 h. In some examples, calcination may comprise heating for up to 8 hours, for example, up to 7 hours, up to 6 hours or up to 5 hours. In some examples, calcination may comprise heating for from 3 hours to 8 hours, for example, 3.5 hours to 7 hours, 4 hours to 6 hours, or 4 hours to 5 hours.

### Halocarbons

The halocarbon may be any compound comprising at least one carbon-halogen bond. The halocarbon may be any organic compound comprising at least one carbon-halogen bond. The halocarbon may be any organic compound comprising a plurality of carbon-halogen bonds.

In some examples, the halocarbon comprises carbon-carbon bonds and carbon-halogen bonds. In some examples, the halocarbon may additionally comprise bonds between carbon and hydrogen and/or bonds between carbon and an electronegative element selected from nitrogen, oxygen, sulfur, selenium and mixtures thereof. In some examples, the halocarbon comprises carbon-carbon bonds, carbon-halogen bonds and carbon-oxygen bonds. In some examples, the halocarbon comprises carbon-carbon bonds, carbon-halogen bonds and carbon-hydrogen bonds. In some examples, the halocarbon comprises carbon-carbon bonds, carbon-halogen bonds, carbon-oxygen bonds and carbon-hydrogen bonds. In some examples, the halocarbon does not comprise carbon-carbon bonds. In some examples, the halocarbon comprises carbon-halogen bonds and carbon-hydrogen bonds. In some examples, the halocarbon comprises carbon-halogen bonds and carbon-oxygen bonds. In some examples, the halocarbon comprises carbon-halogen bonds, carbon-hydrogen bonds and carbon-oxygen bonds.

In some examples, the halogen may be fluorine, chlorine, bromine, iodine or a mixture thereof. In some examples, the halogen is selected from fluorine, chlorine and mixtures thereof. In some examples, the halogen may be fluorine. In some examples, the halogen may be a mixture of chlorine and fluorine. In some examples, the halogen may be chlorine.

In some examples, the halocarbon may be selected from fluorocarbon compounds, chlorocarbon compounds, chlorofluorocarbon compounds (CFCs) and hydrochlorofluorocarbon compounds (HCFCs).

In some examples, the halocarbon may be a polymeric halocarbon, a haloalkene, a haloalkane or a mixture thereof.

In some examples, the halocarbon may be a polymer. In some examples, the polymeric halocarbon may be decomposed into haloalkenes prior to reacting with the metal salt. In some examples, the polymeric halocarbon may be a polymer or copolymer of monomers comprising at least one halogen atom. In some examples, the polymeric halocarbon may be a polymer of halogenated alkenes, halogenated alkoxy alkenes, and mixtures thereof.

In some examples, the polymeric halocarbon may be a polymer of halogenated ethene, halogenated propene, halogenated alkoxyethene, halogenated methoxyethene, halogenated ethoxyethene and mixtures thereof. In some examples, the polymeric halocarbon may be a polymer of tetrahaloethene, hexahalopropylene, vinyl halide, hexahalomethyl vinyl ether, and mixtures thereof. In some examples, the polymeric halocarbon may be a polymer of tetrafluoroethene, tetrachloroethene, hexafluoropropylene, hexachloropropylene, vinyl fluoride, vinyl chloride, hexafluoromethyl vinyl ether, hexachloromethyl vinyl ether and mixtures thereof.

In some examples, the polymeric halocarbon is a perhalogenated compound, for example, a perfluorinated compound.

In some examples, the polymeric halocarbon may be selected from polytetrafluoroethylene (PTFE), perfluoroalkoxy alkanes (PFA), fluorinated ethylene propylene (FEP), polyvinyl chloride (PVC), polyethylenetetrafluoroethylene (ETFE), polyvinyl fluoride (PVF), polydifluoroethylene (e.g., polyvinylidene fluoride (PVDF)), perfluorosulfonic add polymers (e.g., Nafion™) and mixtures thereof. Polyethylenetetrafluoroethylene is a copolymer of ethylene and tetrafluoroethylene, which may be an alternating copolymer or a random copolymer. Perfluorosulfonic acid polymers may be copolymers of tetrafluoroethylene and sulfonate-terminated perfluorovinyl ethers, such as Nafion™.

In some examples, a perfluoroalkoxy alkane is a copolymer of tetrafluoroethylene and a perfluorinated alkylvinylether, for example, perfluoro methylvinylether. In some examples, fluorinated ethylene propylene (FEP) is a copolymer of hexafluoropropylene and tetrafluoroethylene.

In some examples, the halocarbon is a haloalkene. In some examples, the haloalkene is a fluoroalkene, a chloroalkene, a chlorofluoroalkene, or a mixture thereof. In some examples, the haloalkene is selected from tetrafluoroethylene, perfluoro methylvinylether, hexafluoropropylene, vinyl chloride and mixtures thereof.

In some examples, the halocarbon is a haloalkane. In some examples, the haloalkane is a fluoroalkane, a chloroalkane, a chlorofluoroalkane or a mixture thereof. In some examples, the haloalkane is tetrafluoromethane (carbon tetrafluoride), tetrachloromethane (carbon tetrachloride), dichlorodifluoromethane, difluoromethane, dichloromethane, trichloromethane (chloroform), perfluorosulfonic acid (PFSA), perfluorinated carboxylic acid (PFCA), or mixtures thereof. A perfluorosulfonic acid (PFSA) may be any perfluoroalkylsulfonic acid compound, for example, a C1 to C20 perfluoroalkylsulfonic acid, a C1 to C10 perfluoroalkylsulfonic acid or a C1 to C6 perfluoroalkylsulfonic acid. A perfluorinated carboxylic acid (PFCA) may be any perfluorinated carboxylic acid, for example, a C1 to C20 perfluorinated carboxylic acid, a C1 to C10 perfluorinated carboxylic acid or a C1 to C6 perfluorinated carboxylic acid.

### Metal Salts

The metal salt may comprise a metal and an electronegative element selected from nitrogen, oxygen, sulfur, chlorine, selenium, bromine, iodine, or a mixture thereof. The halogen of the halocarbon may be more electronegative than the electronegative element of the metal salt. In some examples, the metal salt may be a mixture of metal salts.

The electronegativity of the electronegative element may be measured using the Pauling scale. According to the Pauling scale, the relative electronegativity of these electronegative elements is as follows (from highest to lowest): fluorine, oxygen, chlorine, nitrogen, bromine, iodine, sulfur, selenium.

In some examples, the metal salt may be a salt of a metal and an anion comprising an electronegative element selected from nitrogen, oxygen, fluorine, sulfur, chlorine, selenium, bromine, iodine and a mixture thereof. In some examples, the anion may consist of an electronegative element selected from nitrogen, oxygen, fluorine, sulfur, chlorine, selenium, bromine, iodine and a mixture thereof.

In some examples, the anion may comprise oxygen, chlorine, nitrogen, bromine or a mixture thereof. In some examples, the anion may comprise oxygen, chlorine, nitrogen or a mixture thereof. In some examples, the anion may be oxide, hydroxide, carbonate, chloride, nitride, nitrate, acetate, formate or a mixture thereof. In some examples, the anion may be oxide, carbonate or a mixture thereof.

In some examples, the metal salt is a metal oxide, metal hydroxide, metal carbonate, metal chloride, metal nitride, metal nitrate, metal acetate, metal formate or a mixture thereof. In some examples, the metal salt is a metal oxide, metal hydroxide, metal carbonate, or mixture thereof.

In some examples, the metal salt is a salt of a metal and an anion comprising an electronegative element and the metal salt decomposes to form a salt of the metal and the electronegative element. In some examples, the decomposition is thermal decomposition. In some examples, the thermal decomposition occurs at a lower temperature than the reaction of the halocarbon with the metal oxide.

In some examples, the metal salt is a metal carbonate that decomposes into a metal oxide. In some examples, the metal salt is a metal carbonate that decomposes into a metal oxide and carbon dioxide before the metal oxide reacts with the halocarbon. In some examples, the metal carbonate thermally decomposes into a metal oxide and carbon dioxide. In some examples, the decomposition of the metal carbonate occurs at a lower temperature than the reaction of the halocarbon with the metal oxide. In some examples, the metal carbonate may be Na₂CO₃, K₂CO₃, Rb₂CO₃, Cs₂CO₃, Li₂CO₃, MgCO₃, CaCO₃, SrCO₃, BaCO₃ or a mixture thereof. In some examples, the metal carbonate may be Na₂CO₃ or CaCO₃.

In some examples, the metal salt is a metal hydroxide that decomposes into a metal oxide. In some examples, the metal salt is a metal hydroxide that decomposes into a metal oxide and water before the metal oxide reacts with the halocarbon. In some examples, the metal hydroxide thermally decomposes into a metal oxide and water. In some examples, the decomposition of the metal hydroxide occurs at a lower temperature than the reaction of the halocarbon with the metal oxide. In some examples, the metal hydroxide is KOH.

In some examples, the metal salt is a metal oxide. In some examples, the metal salt is a mixture of metal oxides. In some examples, the metal salt is a metal carbonate. In some examples, the metal salt is a mixture of metal carbonates. In some examples, the metal salt is a metal hydroxide. In some examples, the metal salt is a mixture of metal hydroxides. In some examples, the metal salt is a mixture of a metal oxide, a metal carbonate and/or a metal hydroxide. In some examples, the metal salt is a mixture of a metal oxide and a metal carbonate. In some examples, the metal carbonate decomposes into a metal oxide and carbon dioxide or carbon monoxide under the reaction conditions.

In some examples, the metal hydroxide decomposes into a metal oxide and water under the reaction conditions.

In some examples, the metal salt may comprise any metal. In some examples, the metal may be an alkali metal, an alkaline earth metal, a transition metal, a p block metal, an f block metal or a mixture thereof. In some examples, the p block metal is selected from aluminium, gallium, germanium, indium, tin, antimony, thallium, lead, bismuth or a mixture thereof.

In some examples, the metal is selected from lithium, sodium, potassium, rubidium, caesium, magnesium, calcium, strontium, barium, aluminium, manganese, iron, cobalt, nickel, copper, zinc, ruthenium, palladium, silver, cadmium, osmium, iridium, platinum, gold, mercury, yttrium, lanthanum, cerium, neodymium, promethium, samarium, europium, gadolinium, terbium, dysprosium, holmium, erbium, thulium, ytterbium, lutetium and mixtures thereof. In some examples, the metal is selected from sodium, calcium, aluminium, yttrium and mixtures thereof.

In some examples, the metal salt may be selected from Na₂CO₃, Na₂O, CaCO₃, CaO, Al₂O₃, Y₂O₃, K₂O, K₂O, MgCO₃, MgO, BaCO₃, BaO, MnCO₃, MnO, FeCO₃, iron oxides (e.g., FeO, FeO₂, Fe₂O₃, Fe₃O₄, etc.), cobalt oxide, copper oxide, noble metal oxides, rare earth oxides and mixtures thereof. In some examples, the metal salt may be Na₂CO₃. In some examples, the metal salt may be Na₂O. In some examples, the metal salt may be CaCO3. In some examples, the metal salt may be CaO. In some examples, the metal salt may be a mixture of Na₂CO₃ and Al₂O₃. In some examples, the metal salt may be a mixture of Na₂O and Al₂O₃. In some examples, the metal salt may be a mixture of Na₂CO₃ and Y₂O₃. In some examples, the metal salt may be a mixture of Na₂O and Y₂O₃. In some examples, the metal salt may be a mixture of Na₂CO₃ and CuO. In some examples, the metal salt may be a mixture of Na₂O and CuO. In some examples, the metal salt may be a mixture of Na₂CO₃ and ZnO. In some examples, the metal salt may be a mixture of Na₂O and ZnO. In some examples, the metal salt may be a mixture of Na₂CO₃ and Co₂O₃. In some examples, the metal salt may be a mixture of Na2O and Co₂O₃. In some examples, the metal salt may be a mixture of Na₂CO₃ and Fe₂O₃. In some examples, the metal salt may be a mixture of Na₂O and Fe₂O₃. In some examples, the metal salt may be a mixture of Na₂CO₃ and NiO. In some examples, the metal salt may be a mixture of Na₂O and NiO₃. In some examples, the metal salt may be a mixture of Na₂CO₃and MnO. In some examples, the metal salt may be a mixture of Na₂O and MnO.

### Inorganic Metal Salts Comprising a Halogen

In some examples, the process produces an inorganic salt comprising a halogen. The inorganic salt comprising a halogen may be an inorganic salt of a metal and a halide. In some examples, the inorganic salt comprising a halogen is a solid. In some examples, the inorganic salt comprising a halogen is a solid at the reaction temperature. In some examples, the inorganic salt comprising a halogen is a solid at room temperature (e.g., 20° C. to 25° C.) and pressure (e.g., about 1 atm).

In some examples, the inorganic salt comprising a halide may be a metal halide, a mixed metal halide (for example, a bimetallic halide). In some examples, the inorganic salt comprising a halogen may be a metal fluoride, a metal chloride, a metal bromide or a metal iodide or a mixture thereof. In some examples, the inorganic salt comprising a halogen may be a mixed metal fluoride, a mixed metal chloride, a mixed metal bromide, a mixed metal iodide or a mixture thereof.

In some examples, the inorganic salt comprising a halogen may be selected from NaF, CaF₂, Na₃AlF₆, NaYF₄, KF, MgF₂, BaF₂, MnF₂, FeF₂, CoF₂, CuF₂, FeF₃, AlF₃, BiF₃, LaF₃, CeF₃, PbF₂, AgF₂, AgMnF₄, NaGdF₄, NaMnF₂, Na₃FeF₆, KMnF₃, KFeF₃, KCoF₃, KCuF₃, and KZnF₃. In some examples, the inorganic salt comprising a halogen may be selected from NaF, CaF₂, Na₃AlF₆, NaYF₄, KF, MgF₂, BaF₂, MnF₂, FeF₃, CoF₂, CuF₂, FeF₃, AlF₃ KMnF₃, KFeF₃, KCoF₃, KCuF₃, and KZnF₃. In some examples, the inorganic salt comprising a halogen may be selected from NaF, CaF₂, Na₃AlF₆, and NaYF₄.

### EXAMPLES

The following illustrates examples of the methods and other aspects described herein. Thus, these Examples should not be considered as limitations of the present disclosure, but are merely in place to teach how to make examples of the present disclosure.

### Example 1—Synthesis of NaF

Na₂CO₃ powder (106 mg) was mixed with polytetrafluoroethylene (PTFE; 50 mg) and ground for 15 min. The mixture was placed in a ceramic crucible in a tubular furnace (a Vecstar single tube furnace, VCTF5) for annealing. The annealing process was conducted in a constant flow of N₂ gas (1 L/min) at 1173 K for 4 hours with a heating rate of 5° C./min to produce NaF powder. Post-reaction calcination (673 K for 4 hours, with a heating rate of 10 K/min in a carbonite 18 L Ashing & Burnoff Chamber Furnace, AAF1118-volts) was carried out in air to remove any deposited carbon. During this process, it is believed that Na₂O is formed through decomposition of Na₂CO₃ and the Na₂O then reacts with tetrafluoroethylene.

PTFE→C₂F₄

C₂F₄(g)+2Na₂CO₃(s)→2CO(g)+4NaF(s)+2CO₂(g)

### Example 2—Synthesis of CaF₂

CaF₂ was produced by the process described in Example 1 except that CaCO₃ powder (100 mg) was used instead of Na₂CO₃. During this process, it is believed that CaO is formed through decomposition of CaCO₃ and the CaO then reacts with tetrafluoroethylene.

PTFE→C₂F₄

C₂F₂(g)+2CaCO₃(s)→2CO(g)+2CaF₂(s)+2CO₂(g)

### Example 3—Synthesis of Na₃AlF₆

Na₃AlF₆ was produced by the process described in Example 1 except that Na₂CO₃ (318 mg) and Al₂O₃ (101.96 mg) were mixed with PTFE (300 mg).

PTFE→C₂F₄

3C₂F₄(g)+3Na₂CO₃(s)+Al₂O₃(s)→6CO(g)+2Na₃AlF₆(s)+3 CO₂(g)

### Example 4—Synthesis of NaYF₄

NaYF₄ was produced by the process described in Example 1 except that Y₂O₃ (225.81 mg) and Na₂CO₃ (106 mg) were mixed with PTFE (200 mg). This reaction produced a mixture of aαNaYF₄ and β-NaYF₄.

PTFE→C₂F₄

2C₂F₄(g)+Na₂CO₃(s)+Y₂O₃(s)→4CO(g)+2NaYF₄(s)+CO₂(g)

### Results

Polytetrafluoroethylene (PTFE) is used as a precursor in the reaction and decomposes into tetrafluoroethylene at 673 K. Metal carbonates are used as a precursor for the metal oxide; the metal carbonate decomposes into the metal oxide and carbon dioxide when heated at the temperatures used for the reaction.

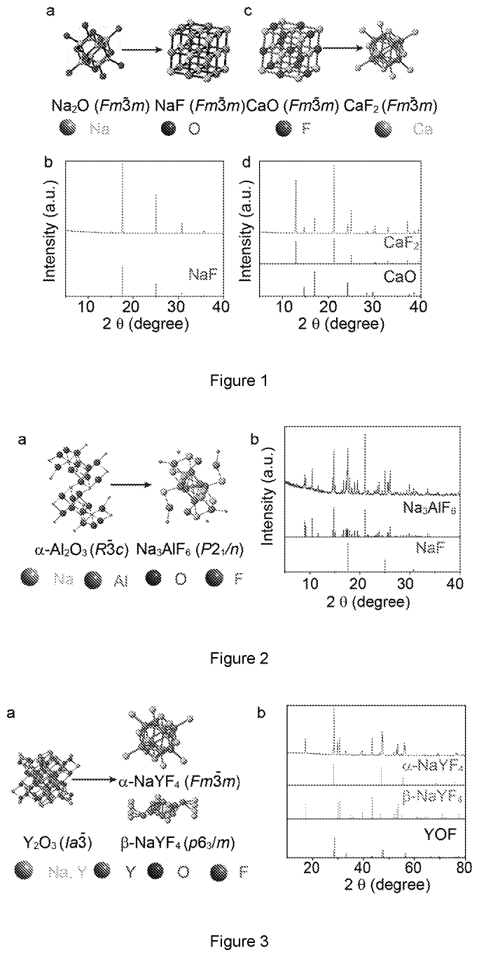

The reactions between PTFE and Na₂CO₃; PTFE and CaCO₃; PTFE, Al₂I₃ and Na₂CO₃; and PTFE, Y₂O₃ and Na₂CO₃ form NaF; CaF₂; Na₃AlF₆; and NaYF₄, respectively (see FIGS. 1, 1c, 2a and 3a), as confirmed by the X-ray diffraction patterns (see FIGS. 1b, 1d, 2b and 3b). All four metal fluorides are produced by simply heating the mixture of PTFE with the metal oxide (or metal carbonate a precursor of the metal oxide) at 1173 K in the presence of N₂. PTFE decomposes into C₂F_{4,} which subsequently reacts with the metal oxide (Na₂O is formed via the decomposition of Na₂CO₃ and CaO is formed via the decomposition of CaCO₃). CO is detected in the gas exhaust. All of the produced compounds are industrially useful. NaF, CaF₂and Na₂AlF₆ are major fluoride chemicals used in industrial and medical contexts, while NaYF₄ is used for optical applications.

### Thermodynamic Analysis of Various Reactions

A thermodynamic analysis of the reactions described in Examples 1 to 4 indicates that the high formation energy of the metal fluorides provides a negative reaction enthalpy, which provides the main driving force for the reaction. Additionally, the release of CO gas leads to a positive entropy change that also favours the reaction.

This reaction (which may be referred to herein as a carbon-metal metathesis reaction) can be extended to many other metals. Table 1 below includes the calculated reaction enthalpy (ΔHᵣ) and entropy (ΔSᵣ) for the reaction to produce a variety of metal fluorides from PTFE:

xC₂F₄(g)+2MOₓ(s)→2xCO(g)+2MF₂ₓ(s)

TABLE 1

| metals | KF | MgF₂ | BaF₂ | MnF₂ | FeF₂ | CoF₂ | CuF₂ | FeF₃ | AlF₃ |
|---|---|---|---|---|---|---|---|---|---|
| ΔHᵣ | −1108 | −605 | −881 | −502 | −473 | −427 | −325 | −599 | −684 |
| [kJ · mol⁻¹] | | | | | | | | | |
| ΔSᵣ | 173 | 156 | 144 | 183 | 148 | 154 | 165 | 252 | 225 |
| [kJ · mol⁻¹ · K⁻¹] | | | | | | | | | |

In addition to PTFE, many other halogen containing polymers are wasted. These include perfluoroalkoxy alkanes (PFA), fluorinated ethylene propylene (FEP), polyvinyl chloride, chlorofluorocarbons (CFCs) and hydrochlorofluorocarbons (HCFCs). These polymers can also be converted into metal salts by this process, producing H₂O, CO, CO₂ or mixtures thereof as by-products. Chemical equations for some of these reactions in which metal oxides are used as the metal salt are included below. However, other salts of a metal and an electronegative element can also be used as the metal salt.

PTFE

nC₂F₄+2MOₙ→2nCO+2MF₂ₙ

PFA

nCF₂CF—OCF₃(g)+3MOₙ(s)→2nCO(g)+nCO₂ₙ(g) and

nC₂F₄+2MOₙ→2nCO+2F₂ₙ

FEP

nCF₂CF—CF₃(g)+3MOₙ(s)→3nCO(g)+3MF₂ₙ(s) and

nC₂F₄+2MOₙ→2nCO+2MF₂ₙ

PVC

2(CH₂CHCl)ₙ(s)+nMO(s)→nMO→nC₄H₆O(g)+nMCl₂(s)

CF₂Cl₂ (an example CFC)

CF₂Cl₂(g)+2MO(s)→CO₂(g)+MCl₂(s)+MF₂(s)

CHF₂Cl (an example HCFC)

2CHF₂Cl(g)+3MO(s)→C₂H₂O₃(g)+MCl₂(s)+2MF₂(s)

Difluoromethane

CH₂Cl₂(g)+MO(s)→CH₂O(g)+MCl₂(s)

Consequently, this process provides a general mechanism for producing halogen containing inorganic salts by recycling halocarbons, such as halogen containing polymers. Although the activation energy of this process is very high (requiring very high temperatures both to decompose the polymer and to react the halocarbon with the metal salt), many of the inorganic salts comprising a halogen are rare but sought after materials.

Although the thermal decomposition of PTFE into tetrafluoroethylene in an inert atmosphere has been reported previously, tetrafluoroethylene is very stable. Indeed, the carbon-fluorine bond is one of the most stable covalent bonds. Despite this high stability, it has been found that this bond can be broken at very high temperature in the presence of an inorganic salt of a metal and an electronegative element such as oxygen.

Thus, although carbon-halogen bonds (particularly the carbon-fluorine bond) are particularly stable covalent bonds, it has been shown that such bonds can be broken at high temperatures in the presence of an inorganic salt of a metal and an electronegative element that is less electronegative than the halogen atom.

While the invention has been described with reference to certain examples, those skilled in the art will appreciate that various modifications, changes, omissions, and substitutions can be made without departing from the spirit of the disclosure. It is intended, therefore, that the invention be limited by the scope of the following claims.

Unless otherwise stated, the features of any dependent claim can be combined with the features of any of the other dependent claims and any of the independent claims.

1. A process for converting halocarbons into inorganic salts comprising a halogen, the process comprising:
reacting a halocarbon with a metal salt to produce the inorganic salt comprising a halogen;
wherein the metal salt comprises a metal and an electronegative element selected from nitrogen, oxygen, sulfur, chlorine, selenium, bromine and iodine, or a mixture thereof;
wherein the halogen of the halocarbon is more electronegative than the electronegative element of the metal salt.

2. The process according to claim 1, wherein reacting a halocarbon with a metal salt comprises heating the halocarbon in the presence of the metal salt.

3. The process according to any preceding claim, wherein the halocarbon is reacted with the metal salt under an inert atmosphere. 15 4. The process according to any preceding claim, wherein reacting a halocarbon with a metal salt comprises heating at a temperature of at least 450 K.

5. The process according to any preceding claim, wherein reacting a halocarbon with a metal salt comprises heating at a temperature of up to 3500 K.

6. The process according to any preceding claim, wherein reacting a halocarbon with a metal salt comprises heating for at least 3 hours.

7. The process according to any preceding claim, wherein reacting a halocarbon with a metal salt comprises heating for up to 7 days.

8. The process according to any preceding claim, wherein the halocarbon and the metal salt are combined and then ground together before the halocarbon is reacted with the metal salt.

9. The process according to claim 8, wherein grinding was performed for at least 10 minutes.

10. The process according to any of claim 8 or 9, wherein grinding was performed for up to 24 hours.

11. The process according to any preceding claim, wherein the by-products of the process are selected from carbon monoxide, carbon dioxide, water, organic compounds of carbon, hydrogen and oxygen, and mixtures thereof.

12. The process according to any preceding claim, wherein the halogen is selected from fluorine, chlorine and mixtures thereof.

13. The process according to any preceding claim wherein the halocarbon comprises an organic compound comprising a plurality of carbon-halogen bonds.

14. The process according to any preceding claim, wherein the halocarbon is selected from fluorocarbons, chlorocarbons, chlorofluorocarbons, and hydrochlorofluorocarbons.

15. The process according to any preceding claim, wherein the halocarbon is a polymeric halocarbon, a haloalkane, a haloalkene or a mixture thereof.

16. The process according to claim 15, wherein the polymeric halocarbon is decomposed into haloalkenes prior to reacting the halocarbon with the metal salt.

17. The process according to any of claims 15 to 16, wherein the polymeric halocarbon is selected from polytetrafluoroethylene (PTFE), perfluoroalkoxy alkanes (PFA), fluorinated ethylene propylene (FEP), polyvinyl chloride (PVC), polyethylenetetrafluoroethylene (ETFE), polyvinyl fluoride (PVF), polydifluoroethylene and mixtures thereof.

18. The process according to any of claims 15 to 17, wherein the polymeric halocarbon is a perfluorinated compound.

19. The process according to claim 18, wherein the perfluoroalkoxy alkane is a copolymer of tetrafluoroethylene and perfluoro methylvinylether.

20. The process according to claim 15, wherein the haloalkene is selected from tetrafluoroethylene, perfluoro methylvinylether, hexafluoropropylene, vinyl chloride and mixtures thereof.

21. The process according to claim 15, wherein the haloalkane is selected from tetrafluoromethane, tetrachloromethane, dichlorodifluoromethane, difluoromethane, dichloromethane, trichloromethane, perfluorosulfonic acid (PFSA), perfluorinated carboxylic acid (PFCAs) and mixtures thereof.

22. The process according to any preceding claim, wherein the metal is selected from lithium, sodium, potassium, rubidium, caesium, magnesium, calcium, strontium, barium, aluminium, manganese, iron, cobalt, nickel, copper, zinc, ruthenium, palladium, silver, cadmium, osmium, iridium, platinum, gold, mercury, yttrium, lanthanum, cerium, neodymium, promethium, samarium, europium, gadolinium, terbium, dysprosium, holmium, erbium, thulium, ytterbium, lutetium and mixtures thereof.

23. The process according to any preceding claim, wherein the metal salt is a metal oxide, metal hydroxide, metal carbonate, metal chloride, metal nitride, metal nitrate, metal acetate, metal formate or a mixture thereof.

24. The process according to any preceding claim, wherein the inorganic salt comprising a halogen is selected from NaF, CaF₂, Na₃AlF₆, NaYF₄, KF, MgF₂, BaF₂, MnF₂, FeF₂, CoF₂, CuF₂, FeF₃, AlF₃, BiF₃, CeF₃, PbF₂, AgF₂, AgMnF₄, NaGdF₄, NaMnF₄, Na₃FeF₆, KMnF₃, KFeF₃, KCoF₃, KCuF₃, and KZnF₃. cm 25. The process according to any preceding claim, wherein the inorganic salt comprising a halogen is selected from NaF, CaF₂, Na₃AlF₆ and NaYF₄.
